(19) United States
(12) Patent Application Publication
(10) Pub. No.: US 2016/0149228 A1
(43) Pub. Date: May 26, 2016

(54) Electrode Catalyst and Fuel cell Using The Same

(71) Applicant: ARBL CO., LTD., Taichung (TW)

(72) Inventors: Tzu-Chieh CHAO, Taichung (TW); Li-Shen YE, Taichung (TW)

(21) Appl. No.: 14/945,999

(22) Filed: Nov. 19, 2015

(30) Foreign Application Priority Data
Nov. 20, 2014 (TW) 103140170

(51) Int. Cl. H01M 4/90

(52) U.S. Cl. CPC H01M 4/9008; H01M 4/9075; H01M 4/9083

(57) ABSTRACT

The present invention discloses an electrode catalyst used in a fuel cell, comprising a support and a catalyst. The catalyst is supported on the support and has major compositions selected from the group consisting of the following: pheophytin and its derivatives, pheophorbide and its derivatives, pyropheophytin and its derivatives, and pyropheophorbide and its derivatives. The present invention also discloses a membrane electrode assembly for a fuel cell and the related fuel cell.

### CROSS-REFERENCE TO RELATED APPLICATION

This application claims the benefit of priority to Taiwan patent application Ser. No. 103140170, filed Nov. 20, 2014, which is also incorporated herein by reference.

### BACKGROUND OF THE INVENTION

1. Field of the Invention

The present invention is generally related to a fuel cell, particularly to a low-temperature type fuel cell.

2. Description of the Prior Art

A fuel cell is a device to convert chemical energy to electric energy and the device can continuously generate electric power by continuously supplying fuel and oxygen gas with no need of charging. The fuel and oxygen gas cannot be mixed in advance but separately supplied to the fuel cell to have separate reactions on the anode (negative electrode) and the cathode (positive electrode), respectively. The fuel of the anode generates electrons after an oxidation reaction, the electrons flow toward the cathode via an external circuit to have a reduction reaction with oxygen gas, and ions generated on the anode or the cathode are transferred via the electrolyte or ion-exchange membrane in the cell so as to form an operating circuit of a cell.

According to the operating temperature, the fuel cell can be categorized into a high-temperature type, medium-temperature type or low-temperature type fuel cell. For a high-temperature type fuel cell, the anode uses hydrogen gas or hydrogen-atom-containing fuel, the cathode uses oxygen gas, and the chemical reaction occurs naturally under the high temperature. Thus, no expensive catalyst is needed and hydrogen and oxygen with high purity are also not required.

Since the low-temperature type fuel cell has a low operating temperature about 80˜120° C., it can be applied to various mobile vehicles and electronic devices and has broad prospects for development. However, the fuel used in the low-temperature type fuel cell, such as hydrogen gas, needs to be catalyzed by a catalyst to enhance the reaction rate. In addition, the purity of hydrogen and oxygen needs to be high for the low-temperature type fuel cell to prevent poisoning the catalyst.

Since the catalyst for the low-temperature type fuel cell is expensive, the proton exchange membrane is also expensive, and the high-purity hydrogen and oxygen gas are needed, the low-temperature type fuel cell has not been large-scale commercialized yet. Therefore, a novel technique to provide a highly-reliable catalyst and a fuel cell using the same with low-production cost and low operating cost is urgently needed.

### SUMMARY OF THE INVENTION

In light of the above market demands, the present invention provides the following embodiments.

In certain embodiments, the present invention provides an electrode catalyst used in a fuel cell, comprising a support and a catalyst. The catalyst is supported on the support and has major compositions selected from the group consisting of the following: pheophytin and its derivatives, pheophorbide and its derivatives, pyropheophytin and its derivatives, and pyropheophorbide and its derivatives.

In certain embodiments, the present invention provides a membrane electrode assembly (MEA), comprising: a first electrode containing a first catalyst layer; a second electrode containing a second catalyst layer; and an electrolyte membrane positioned between the first electrode and the second electrode. One of the first catalyst layer and the second catalyst layer or both comprise the above mentioned electrode catalyst.

In certain embodiments, the present invention provides a fuel cell comprising the above mentioned membrane electrode assembly (MEA).

### BRIEF DESCRIPTION OF THE DRAWINGS

FIG. 1 shows a schematic diagram of the reaction of a fuel cell according to one embodiment of the present invention; and

FIG. 2 shows a schematic diagram of the reaction of a fuel cell according to another embodiment of the present invention.

### DESCRIPTION OF THE PREFERRED EMBODIMENTS

An electro-catalytic reaction is combination of electrochemistry and a catalyst to use a catalytic electrode to have the electrochemical reaction occur at the voltage close to the theoretical voltage and the high current density. The medium-temperature and the low-temperature type fuel cells are electric generating devices using electro-catalytic catalyst to convert chemical energy to electric energy.

The low-temperature type fuel cells include proton exchange membrane fuel cells (PEMFC), direct methanol fuel cells (DMFC), and alkaline fuel cells (AFC), etc.

The proton exchange membrane fuel cell is also called “polymer electrolyte membrane fuel cell” using a porous polymer proton exchange membrane instead of an electrolyte to conduct cations. The proton exchange membrane is used to transmit protons but block electrons and gas from passing through and it has no erosion problem because of containing no strong acid or strong base. Generally, the operating temperature is lower than 200° C., no high pressure or low pressure operation is needed, the anode feed is hydrogen gas or hydrogen-atom-containing fuel, the cathode feed is oxygen gas, the metallic catalyst uses precious metal such as platinum, gold, palladium, etc., and pure water and heat are generated after electricity is generated.

The alkaline fuel cell (AFC) usually uses asbestos webs as a electrolyte carrier and a potassium hydroxide solution as the electrolyte for conducting cations and anions and has an operating temperature at about 70˜200° C. The anode feed is high-purity hydrogen gas as fuel and the cathode feed is high-purity oxygen gas as an oxidant, and the metallic catalyst uses precious metal such as platinum, gold, palladium, etc. or transition metal such as nickel, cobalt, manganese etc. The alkaline fuel cell (AFC) is currently successfully applied to aerospace industrial or military purposes.

In a low-temperature type fuel cell, the catalyst of the anode (negative electrode) usually is platinum. In order to increase the surface area of the reaction and reduce the usage of precious metal, platinum with a particle size of about or less than 10 nm is used and is also called “platinum black” because platinum losses metallic luster and appears to be black when the particle size reduces to a nano-meter scale. In order to increase the area for the reaction, a carbon carrier with larger dispersibility is used and thus it is called “carbon supported platinum catalyst” where only 0.5 mg/cm² of platinum is needed to catalyze the electro-catalytic oxidation of hydrogen.

A hydrogen molecule adsorbs on the surface of a platinum particle and decomposes into separate hydrogen atoms to adsorb on a platinum atom. Due to the influence of electrochemical potential, the hydrogen atom is oxidized to become a proton (hydrogen ion) and an electron. The proton moves toward the cathode via the proton exchange membrane and the electron is transferred via the nearby platinum metal conductor to the supporting carbon structure and finally transferred to the external circuit. The above process is the electric energy generating mechanism of a proton exchange membrane fuel cell. In an alkaline fuel cell, there are more usable catalysts to choose and especially an electro-catalytic catalyst used in oxidation of hydrogen can be nickel or other metals.

In a low-temperature type fuel cell, carbon-supported platinum is still mainly used as the catalyst of the cathode (positive electrode) but non-precious metal complex can be used for an alkaline fuel cell.

A first embodiment of the invention discloses an electrode catalyst used in a fuel cell, comprising a support and a catalyst. The support can comprise one material selected from the group consisting of the following or combination thereof: porous carbon, conductive carbon powder, and conductive polymer. The catalyst is supported on the support and has major compositions selected from the group consisting of the following: pheophytin and its derivatives, pheophorbide and its derivatives, pyropheophytin and its derivatives, and pyropheophorbide and its derivatives (hereinafter abbreviated as “pheophytin series catalyst”). In one embodiment, the electrode catalyst catalyzes an oxidation reaction of hydrogen gas or methanol. In another embodiment, the electrode catalyst catalyzes a reduction reaction of oxygen gas.

The molecular dimension of the “pheophytin series catalyst” is of nano meter scale and the pheophytin series catalyst exists in nature with no need of additional nano-meter scaling processing. The support can disperse the catalyst to increase the area of the reaction so as to increase the reaction rate.

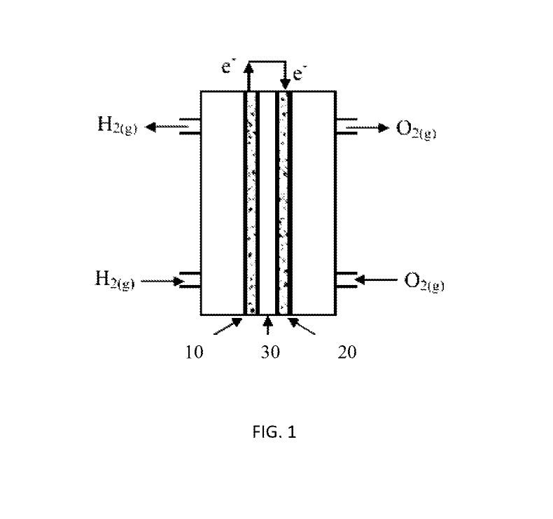

Please refer to FIG. 1. A second embodiment of the invention discloses a membrane electrode assembly (hereinafter abbreviated as “MEA”). The membrane electrode assembly comprises: a first electrode 10 containing a first catalyst layer; a second electrode 20 containing a second catalyst layer; and an electrolyte membrane 30 positioned between the first electrode 10 and the second electrode 20. One of the first catalyst layer and the second catalyst layer or both comprise an electrode catalyst and the electrode catalyst is the electrode catalyst mentioned in the first embodiment.

In one embodiment, the electrolyte membrane 30 is an acidic cation-exchange membrane. The first electrode 10 (negative electrode) undergoes the oxidation reaction of hydrogen gas (equation (1)) and the generated electrons are transferred to oxygen gas of the second electrode 20 (positive electrode). Oxygen gas is reduced to obtain electrons and form oxygen ions and the proton generated on the negative electrode is transferred to the positive electrode via the acidic cation-exchange membrane to form water with the oxygen ion (equation (2)). The total reaction is shown in equation (3).

H₂→2H⁺+2e⁻ (1)

½O₂+2H⁺+2e⁻→H₂O (2)

H_{2(g)}+½O_{2(g)}→H₂O₍ₗ₎ (3)

In another embodiment, the electrolyte membrane 30 is an alkaline anion-exchange membrane, for example, Neosepta series anionic membrane and Morganei-ADP series anionic membrane. Hydrogen gas is in contact with hydroxide ions on the first electrode 10 (negative electrode) to have an oxidation reaction to generate water and electrons (equation (4)). The electrons provide electric power via the external circuit and flow back to the second electrode 20 (positive electrode). Oxygen, water and electrons undergo a reduction reaction to form hydroxide ions (equation (5)). Finally, water vapor and heat get away from the exit and the hydroxide ions are transferred to the first electrode 10 (negative electrode) via the alkaline anion-exchange membrane to complete the whole circuit. The total reaction is shown in equation (6).

H₂+2OH⁻→2H₂O+2e⁻ (4)

½O₂+H₂O+2e⁻→2OH⁻ (5)

H_{2(g)}+½O_{2(g)}→H₂O₍ₗ₎ (6)

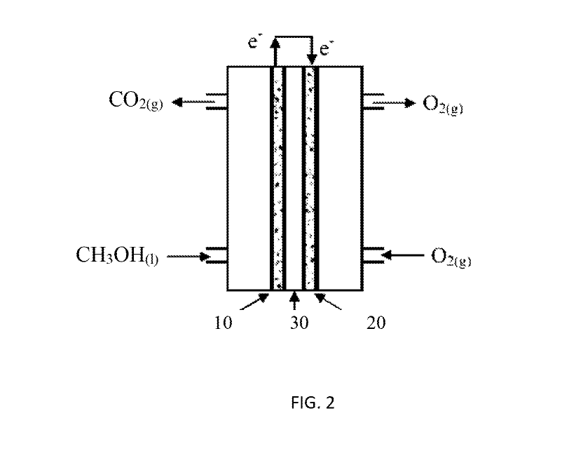

Please refer to FIG. 2. In another one embodiment, a membrane electrode assembly (MEA) is used in a direct methanol fuel cell. The electrolyte membrane 30 is an acidic cation-exchange membrane. Methanol fuel is injected to the acidic solution of the first electrode 10 (negative electrode) and carbon dioxide and hydrogen ions are generated (equation (7)) after oxidation under the condition of catalyzing by a catalyst. Hydrogen ions move to the second electrode 20 (positive electrode) and form into water with the reduced oxygen ions on the positive electrode (equation (8)). The total reaction is shown in equation (9).

CH₃OH+H₂O→CO₂+6H⁺+6e⁻ (7)

O₂+4H⁺+4e⁻→2H₂O (8)

CH₃OH₍ₗ₎+ 3/2O_{2(g)}→CO_{2(g)}+H₂O₍ₗ₎ (9)

The electrode catalyst can catalyze only the oxidation reaction of hydrogen gas on the first electrode 10 (negative electrode) or catalyze only the reduction reaction of oxygen gas on the second electrode 20 (positive electrode). The electrode catalyst can have catalytic effect under the acidic or alkaline condition.

The electrode catalyst can also simultaneously catalyze the oxidation reaction of hydrogen gas on the first electrode 10 (negative electrode) and the reduction reaction of oxygen gas on the second electrode 20 (positive electrode). Generally, a low work function material is suitable to be used as the negative electrode and a high work function material is suitable to be used as the positive electrode. As an inactive electrode is used as the negative electrode and the positive electrode and the same catalyst is used, the work functions for both electrodes are theoretically the same. However, the work functions of electrodes can be different because of different environments in which the electrodes are. For example, the negative electrode is in an environment of hydrogen gas and the positive electrode is in an environment of oxygen gas. Although the same electrode catalysts for the positive and the negative electrode catalysts are used, the electro-catalytic reaction can still take place. For example, the structure of platinum (negative electrode, surrounded by hydrogen gas)-platinum (positive electrode, surrounded by oxygen gas) is a core of the operation of a typical low-temperature type fuel cell.

In a conventional direct methanol fuel cell, since methanol can penetrate the perfluorinated membrane to reach the positive electrode (cathode), the choices of cathode catalyst is very limited. However, this embodiment provides the “pheophytin series catalyst” to simultaneously catalyze the oxidation reaction of methanol on the first electrode 10 (negative electrode) and the reduction reaction of oxygen gas on the second electrode 20 (positive electrode) under the existence of methanol to provide a feasible solution.

A third embodiment of the invention discloses a fuel cell comprising the above mentioned membrane electrode assembly. The first electrode 10 is used to receive a negative electrode feed and the second electrode 20 is used to receive a positive electrode feed. In one embodiment, there are two diffusion layers on the two outer sides of the membrane electrode assembly (MEA) respectively. For example, hydrophobic-treated carbon fibers can let the reactant diffuse to the first catalyst layer and the second catalyst layer and let the product be discharged through diffusion. The laminar flow field plates are positioned on the two outer sides of the diffusion layers and the surface in contact with the diffusion layer comprises many gas flow channels. The reactant and the product can enter and exit the MEA via the gas flow channels.

The negative electrode feed used in the fuel cell has hydrogen gas or other hydrogen-atom containing fuel as its major composition. Also, the major composition of the negative electrode feed can be methanol The major composition of the positive electrode feed can be oxygen gas. Taking hydrogen gas as an example, the production method can be (1) directly decomposition of water to obtain hydrogen gas and oxygen gas; (2) the dehydrogenation reaction of a hydrocarbon compound; (3) steam reforming reaction to generate hydrogen; and (4) hydrogen release from a compound (boron hydride compound). The method (1) consumes a large amount of energy and the method (3) uses the steam reforming reaction of methanol and water which is currently the most economical source of hydrogen generation. However, in the steam reforming reaction, the by-product, carbon monoxide, is the main factor to decrease the efficiency of the electrode and requires many processing steps to remove before hydrogen gas can be led to the membrane electrode assembly (MEA).

Temperature has great influence to the catalytic reaction kinetics. As the temperature is low, carbon monoxide (CO) compete with hydrogen gas (H₂) in the adsorption process and has advantages, that is, carbon monoxide has the priority to shield the active sites of platinum catalysts. The adsorption strength of molecules to most of metals has the following order: O₂>C₂H₂>C₂H₄>CO>H₂>CO₂>N₂. As the temperature is raised to 130° C., the allowable CO concentration of the reformed fuel for the electrochemical reaction of the negative electrode is increased to 1,000 ppm. At 80° C., the allowable CO concentration is about 10˜20 ppm. As the temperature is raised to 200° C., the allowable CO concentration is greatly increased to 30,000 ppm (about 3%). However, the high operating temperature makes the structure of the system complicated and also is inconvenient in use.

This embodiment discloses a fuel cell comprising the above mentioned membrane electrode assembly. Since the “pheophytin series catalyst” is used, at the condition of the low operating temperature and the concentration of the low-purity hydrogen gas (for example the negative electrode feed contains more than 3% of carbon monoxide), the catalytic reaction of hydrogen gas on the negative electrode can normally take place. Preferably, the catalytic reaction of hydrogen gas on the negative electrode takes place at the condition the negative electrode feed contains more than 5% of carbon monoxide.

The “pheophytin series catalyst” used in this embodiment can make the catalytic reaction of oxygen gas take place normally at the low operating temperature (for example, less than or equal to 70° C.) and the concentration of the low-purity oxygen gas (for example, the concentration of oxygen gas is less than or equal to 50%). Preferably, the catalytic reaction of oxygen gas on the positive electrode takes place by directly using air as the positive electrode feed (that is, the concentration of oxygen gas is less than or equal to 20%).

In one embodiment, at the alkaline environment, the first catalyst layer and the second catalyst layer use the same pheophtin and the total power obtained from the fuel cell is the same as a fuel cell using the same operating conditions and ⅓ of the area of platinum catalyst. However, the cost of the “pheophytin series catalyst” is much lower than platinum catalyst. Therefore, the commercialization of the low-temperature type fuel cell becomes more feasible.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An electrode catalyst used in a fuel cell, comprising:
a support; and
a catalyst being supported on the support and having major compositions selected from the group consisting of the following: pheophytin and its derivatives, pheophorbide and its derivatives, pyropheophytin and its derivatives, and pyropheophorbide and its derivatives.

2. The electrode catalyst according to claim 1, wherein the electrode catalyst catalyzes an oxidation reaction of hydrogen gas or methanol.

3. The electrode catalyst according to claim 1, wherein the electrode catalyst catalyzes a reduction reaction of oxygen gas.

4. The electrode catalyst according to claim 1, wherein the support comprises one material selected from the group consisting of the following or combination thereof: porous carbon, conductive carbon powder, and conductive polymer.

5. A membrane electrode assembly (MEA), comprising:
a first electrode containing a first catalyst layer;
a second electrode containing a second catalyst layer; and
an electrolyte membrane positioned between the first electrode and the second electrode;
wherein one of the first catalyst layer and the second catalyst layer or both comprise an electrode catalyst and the electrode catalyst comprises:
a support; and
a catalyst being supported on the support and having major compositions selected from the group consisting of the following: pheophytin and its derivatives, pheophorbide and its derivatives, pyropheophytin and its derivatives, and pyropheophorbide and its derivatives.

6. The membrane electrode assembly according to claim 5, wherein the electrode catalyst catalyzes an oxidation reaction of hydrogen gas or methanol.

7. The membrane electrode assembly according to claim 5, wherein the electrode catalyst catalyzes a reduction reaction of oxygen gas.

8. The membrane electrode assembly according to claim 5, wherein the electrolyte membrane comprises an alkaline anion-exchange membrane or acidic cation-exchange membrane.

9. A fuel cell comprising the membrane electrode assembly according to claim 5, wherein the first electrode is used to receive a negative electrode feed and the second electrode is used to receive a positive electrode feed.

10. The fuel cell according to claim 9, wherein the negative electrode feed has major compositions including hydrogen gas or hydrogen-atom containing fuel.

11. The fuel cell according to claim 9, wherein the negative electrode feed comprises more than 3% of carbon monoxide.

12. The fuel cell according to claim 9, wherein the positive electrode feed comprises oxygen gas with concentration less than or equal to 50%.

13. The fuel cell according to claim 9, wherein the fuel cell has an operating temperature less than or equal to 70° C.

14. The fuel cell according to claim 9, wherein the negative electrode feed has methanol as a major composition.
